(19) United States
(12) Patent Application Publication
(10) Pub. No.: US 2017/0023289 A1
(43) Pub. Date: Jan. 26, 2017

(54) ICE CHEST PROVIDING RECYCLED POTABLE WATER

(71) Applicant: Joyce R. Anderson, Austin, TX (US)

(72) Inventor: Joyce R. Anderson, Austin, TX (US)

(21) Appl. No.: 15/283,643

(22) Filed: Oct. 3, 2016

Related U.S. Application Data
(63) Continuation-in-part of application No. 14/254,040, filed on Apr. 16, 2014.

(51) Int. Cl. F25D 3/08; B65D 81/38; F25D 25/00; B65D 25/42; C02F 1/00; A45C 11/20; B65D 1/24

(52) U.S. Cl. CPC F25D 3/08; A45C 11/20; B65D 81/3825; B65D 1/24; B65D 25/42; C02F 1/001; F25D 25/005; C02F 2307/10; F25D 2323/121; F25D 2303/081; F25D 23/126

(57) ABSTRACT

An ice chest includes a main body and a hinged lid. The main body includes a first internal compartment, second internal compartment and third internal compartment. The first and second internal compartments are separated from one another by a barrier that is capable of thermal transfer, but prohibits liquid transfer. The third internal compartment is positioned directly below the first and second internal compartments and positioned above the bottom of the main body. The third internal compartment is also capable of retaining liquid received through the first internal compartment. A porous barrier is positioned between the first and third internal compartments and filters liquid flowing from the first to the third internal compartment. The main body also includes a filtered spout capable of providing a second filtering mechanism and a release mechanism for liquid being retained in the third internal compartment.

### CROSS REFERENCE TO RELATED APPLICATION

The present application is a continuation-in-part of U.S. patent application Ser. No. 14/254,040, filed on Apr. 16, 2014, now pending, incorporated by reference herein in its entirety.

### FIELD

The present invention relates to a portable ice chest, in particular, a portable ice chest that can provide potable water.

### BACKGROUND

Ice chests and portable ice chests are known and widely used. For example, see www.coleman.com. A user of conventional ice chests generally will encounter various drawbacks to these devices. The first is that where beverages or food are stored in an ice chest, and the ice ultimately melts into water, a user retrieving beverage or food stored in the ice chest will be forced to submerge their hand in the cold water, which may not be desirable. Another drawback of a conventional ice chest is that the water in the ice chest that results from the melting ice is not drinkable, due to contamination from the items stored in the ice chest. Such water is generally disposed of without further use. The presently described invention aims to provide a solution to the above-stated problems.

### SUMMARY

In one aspect, the present description relates to an ice chest. The ice chest includes a main body and a hinged lid. The main body is made up in part of a bottom, two opposing elongate sides, and two opposing sides. The hinged lid is capable of being positioned over the main body and sealing the ice chest. The main body also includes a first internal compartment, second internal compartment and third internal compartment. The first and second internal compartments are separated from one another by a barrier that is capable of thermal transfer, but prohibits liquid transfers. The third internal compartment is positioned directly below the first and second internal compartments and positioned above the bottom of the main body. The third internal compartment is also capable of retaining liquid. The main body of the ice chest further includes a porous barrier that is positioned between the first and third internal compartments. The porous barrier is capable of filtering liquid, such as melted ice, traveling between the first and third internal compartments. The main body of the ice chest also has a filtered spout that is positioned on one of the opposing end sides of the third internal compartment. The filtered spout is capable of providing a second filtering mechanism and a release mechanism for liquid being retained in the third internal compartment.

In another aspect, the present description relates to an ice chest that includes a first compartment adapted to hold a quantity of ice. When ice melts, water exits the first compartment of the ice chest but remains contained within the ice chest. The melted ice is received in a reservoir. A purifying filter can also be included to purify the water prior to release from the reservoir via a spout.

### BRIEF DESCRIPTION OF THE DRAWINGS

FIG. 1 is a partial perspective view of an ice chest according to an aspect of the invention.

FIG. 2 is an isometric side view of an ice chest according to another aspect of the invention.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

In the following detailed description of the preferred embodiments, reference is made to the accompanying drawings, which illustrate specific embodiments in which the invention may be practiced. The illustrated embodiments are not intended to be exhaustive of all embodiments according to the invention. It is to be understood that other embodiments may be utilized and structural or logical changes may be made without departing from the scope of the present invention. The following detailed description, therefore, is not to be taken in a limiting sense, and the scope of the present invention is defined by the appended claims.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above those other elements.

As used herein, when an element, component or layer for example is described as forming a “coincident interface” with, or being “on” “connected to,” “coupled with,” “stacked on” or “in contact with” another element, component or layer, it can be directly on, directly connected to, directly coupled with, directly stacked on, in direct contact with, or intervening elements, components or layers may be on, connected, coupled or in contact with the particular element, component or layer, for example. When an element, component or layer for example is referred to as being “directly on,” “directly connected to,” “directly coupled with,” or “directly in contact with” another element, there are no intervening elements, components or layers for example.

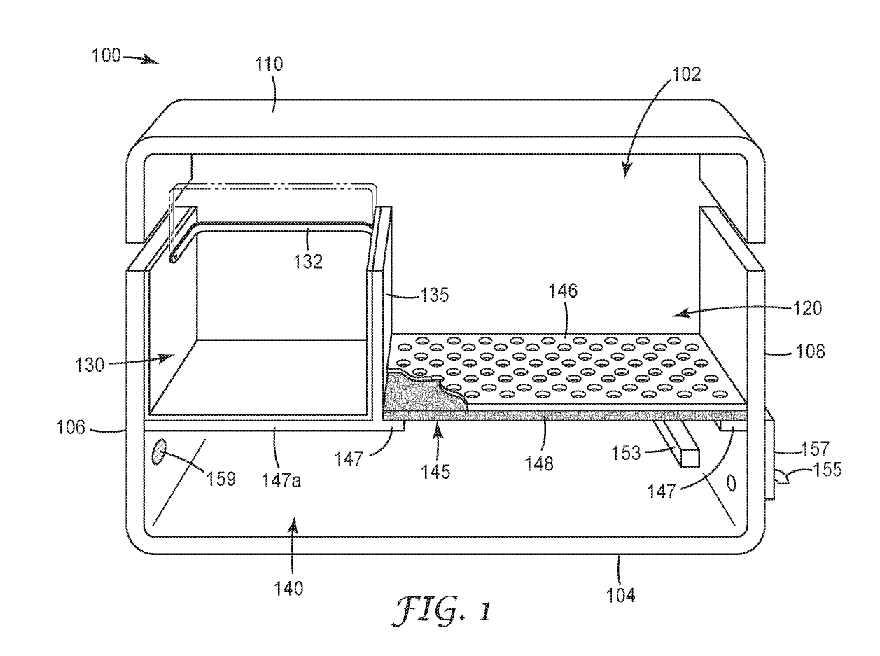

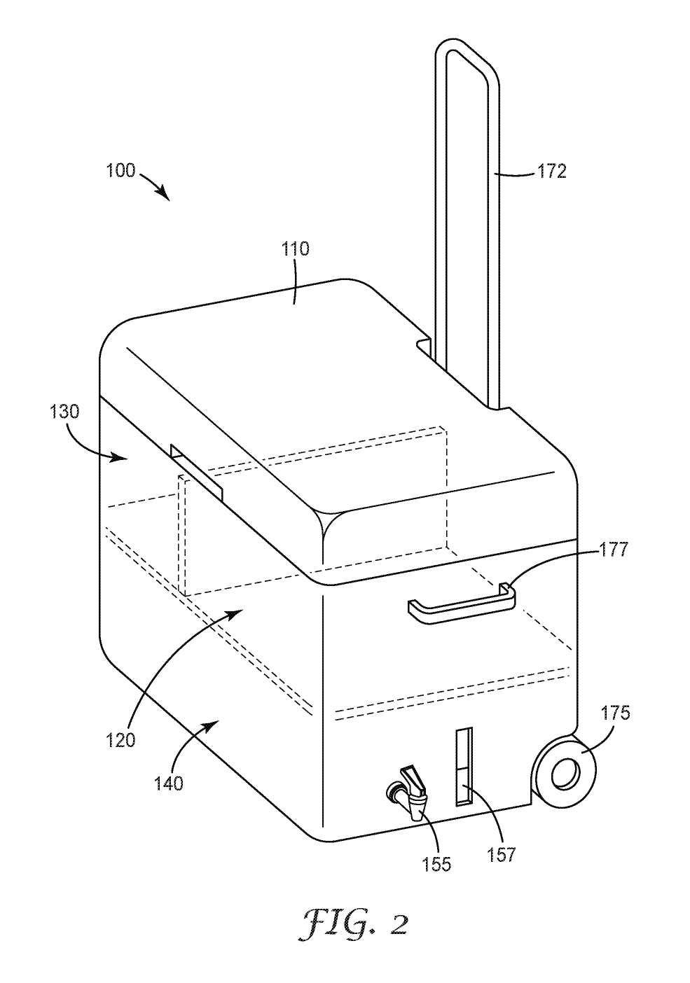

According to a first aspect of the invention, a portable cooler or ice chest 100 is shown in FIG. 1. A side view of ice chest 100 is shown in FIG. 2. Ice chest 100 includes a main body 102, the main body comprising a bottom 104, two opposing elongate sides (the front and rear sides are not shown for simplicity), and two opposing end sides 106, 108. The walls of ice chest 100 can be constructed from conventional insulating materials with a rugged exterior commonly used in commercially available ice chests and coolers.

Ice chest 100 further includes a lid 110 capable of being hinged and positioned over the main body 102. When closed, lid 110 seals the ice chest 100. Lid 110 can have a hard or soft exterior surface. In addition, lid 110 can include a pullout dual cup holder (not shown).

The main body 102 further includes multiple internal compartments. For example, in the embodiment shown in FIG. 1, the main body 102 includes three separate compartments. A first compartment comprises internal compartment 120. In one aspect, internal compartment 120 is configured to contain ice and/or bottled beverages. Main body 102 also includes a second internal compartment 130 positioned adjacent to internal compartment 120. In one aspect, second internal compartment 130 is configured to contain food, ice, ice packs, and/or bottled beverages. In this aspect of the invention, the second internal compartment 130 is separated by the first internal compartment 120 by a barrier 135 that is capable of thermal transfer, but that prohibits liquid transfer between the compartments 120, 130. As such, barrier 135 is configured to prevent food spillage or liquid flow between compartment 130 and compartment 120, thus reducing the likelihood of potential contamination of ice stored in compartment 120.

In one aspect, internal compartment 130 can have a smaller size/volume than compartment 120. In another aspect, internal compartment 130 can have a larger size/volume than compartment 120. In yet another aspect, internal compartment 130 can have the same size/volume as compartment 120.

In another aspect, compartment 130 can be a removable compartment. For example, a handle 132 can be provided to allow a user to remove compartment 130 when the ice chest is opened. In this aspect, main body 102 can include mechanism, such as slots, guides, or tracks, that slidingly receive removable compartment 130 and allow for the straightforward insertion or removal of the removable compartment 130. For example, as shown in FIG. 1, the removable compartment 130 can rest on a barrier or internal wall structure 147a, which can provide for thermal transfer between compartment 130 and compartment 140 and can prevent liquid flow between compartment 130 and compartment 140.

The main body 102 further includes a third internal compartment 140 positioned directly below the first and second internal compartments 120, 130 and positioned above the bottom 104 of the main body 102. According to an aspect of the invention, the third internal compartment 140 is capable of retaining liquid. In this respect, third internal compartment 140 can be referred to as a reservoir 140.

In one example, a porous barrier 145 is positioned between the first and third internal compartments 120, 140. The porous barrier 145 can also be configured to filter liquid flowing between the first and third internal compartments 120, 140. In one aspect, the porous barrier 145 can be constructed as a single piece porous membrane. In another aspect, such as shown in FIG. 1, the porous barrier 145 can be constructed as a two part structure that includes a porous shelf 146 that allows liquid to pass through (and, in some instances, capture macro particles) and a filter 148 that filters the liquid entering compartment 140. In this aspect, filter layer 148 can be positioned within compartment 120 on internal ledge features 147. Simple fastening mechanisms (not shown) can be used to hold filter 148 and/or shelf 146 in place. As such, the lower compartment 140 can capture filtered water resulting from melted ice placed in the first compartment 120. In one aspect the porous shelf can be removable so that the filter 148 can be replaced on a regular basis. Alternatively, filter 148 can be cleaned using a hose or pressurized water spray.

In addition, ice chest 100 can further include a filter-spout combination, referred to herein as a filtered spout 155, positioned on one of the opposing end sides of the reservoir 140 (in FIG. 1, side 108). The filtered spout 155 can provide a second filtering mechanism (in addition to the filtering performed by the filter portion of porous barrier 145 in some aspects). In one aspect, the additional filtering can be provided by a cartridge-type filter 153, disposed at or near and in fluid communication with spout 155. The filter 153 can comprise a replaceable filter. In one aspect, the replaceable filter comprises a conventional water filter, such as those available from Brita (www.brita.com). In addition, filtered spout 155 also provides a release mechanism for liquid being retained in reservoir 140. Thus, this filtering arrangement can be capable of providing a source of potable water.

In another aspect of the invention, ice chest 100 can further include a visual indicator 157 that communicates a condition of the secondary filter. For example, if the condition of the secondary filter is good, the visual indicator 157 can provide a green light indication. If the condition of the secondary filter is not good (e.g., the secondary filter needs to be replaced), then the visual indicator can provide a red light. Other colors or visual indication symbols may also be utilized.

In another aspect of the invention, as shown in FIG. 2, the ice chest can further include a collapsible handle 172 that can be positioned on an external portion of one side of the ice chest, The collapsible handle is configured to extend to a desired height upon actuation of a handle release mechanism. In addition, one or more side handles 177 can also be provided.

In another aspect of the invention, the ice chest 100 further includes an additional drain spout 159 positioned on an end side (e.g., side 106) opposite the end side (e.g., side 108) on which the filtered spout 155 is positioned. The additional drain spout 159 can include an integral or separate end cap (not shown).

Additionally, ice chest 100 can further include at least two wheels (wheel 175 is shown in FIG. 2) positioned beneath the bottom of the main body proximate one of the opposing ends to provide additional ease of transportability. In one aspect, the wheels are configured to pivot and/or are configured to be collapsible.

With the configuration described above, ice chest 100 provides a first compartment 120 adapted to hold a quantity of ice, wherein as ice melts, water exits the first compartment 120 but remains contained within the ice chest in reservoir 140. Thus, if beverages are cooled in compartment 120, even as the ice melts, the beverages are not sitting in a pool of water, thus reducing the likelihood a user would have to submerge his or her hand into an ice cold pool. In addition, ice chest 100 provides a macro filter (e.g., barrier 145) so that the water contained in the reservoir 140 has undergone some filtering. The inclusion of a filtered spout 155 thus provides a source of potable water that can be consumed by the user, without having to waste the water.

In addition, the replaceable filter 135 can comprise a purifying water filter, such as is available from The Berkey (www.theberkey.com). As such, water collected in the reservoir compartment 140 can be purified prior to release from spout 155. Thus, in extreme conditions, questionable or normally non-potable sources of water, such as from a river or stream, can be deposited in compartment 120 and filtered and purified by cooler or ice chest 100. In this manner, the portable cooler or ice chest 100 is a multifunctional device that provides not only a portable cooler for normal recreational activities, but can also provide a source of potable water and/or of filtered, purified water if other sources of potable water are not otherwise available.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A portable ice chest, comprising:
a main body, the main body comprising a bottom, two opposing elongate sides, and two opposing end sides; and
a hinged lid capable of being positioned over the main body and sealing the ice chest;
wherein the main body further comprises:
a first internal compartment and a second adjacent internal compartment arranged in a side-by-side manner, the first compartment being separated from the second compartment by a vertical barrier that permits thermal transfer, but prohibits liquid transfer, wherein the first and second internal compartments have open tops that are covered by the hinged lid when placed in a closed position, wherein the first compartment holds ice and the second compartment is removable;
a third internal compartment positioned directly below the first and second internal compartments and positioned above the bottom of the main body, the third internal compartment retaining melted ice water formed by ice melting from the first compartment;
a barrier disposed between the removable second compartment and the third internal compartment that prevents the flow of melted ice water into the removable second compartment;
a porous barrier positioned between the first and third internal compartments, the porous barrier having a first filter that filters the melted ice water traveling between the first and third internal compartments; and
a second filter disposed at or near and in fluid communication with a spout positioned on one of the opposing end sides of the third internal compartment, the second filter and spout in fluid communication with and providing a second filtering mechanism and release mechanism for the filtered melted ice water being retained in the third internal compartment to provide a source of potable water.

2. The portable ice chest of claim 1, wherein the first filter comprises a pre-filter that captures macro particles and a secondary filter that purifies the melted ice water such that the melted ice water is potable.

3. The portable ice chest of claim 2, further comprising a visual indicator that communicates a condition of the secondary filter.

4. The portable ice chest of claim 1, further comprising a collapsible handle positioned on an external side, the collapsible handle being capable of extending to a desired height upon actuation of a handle release mechanism.

5. The portable ice chest of claim 1, further comprising a drain spout positioned on an end side opposite the end side on which the second filter and spout are positioned.

6. The portable ice chest of claim 1, further comprising at least two wheels positioned beneath the bottom of the main body proximate one of the opposing ends.

7. The portable ice chest of claim 6, wherein the wheels are capable of pivoting and are collapsible.

8. The portable ice chest of claim 1, wherein the removable second compartment includes a handle to allow a user to remove the removable second compartment from the ice chest when the hinged lid is placed in an open position.

9. A portable ice chest comprising:
a first compartment adapted to hold a quantity of ice, wherein as ice melts, melted ice water exits the first compartment into a reservoir compartment;
a first filter system disposed between and in fluid communication with the first compartment and the reservoir compartment, wherein the first filter system includes:
a pre-filter that captures macro particles, and
a secondary filter that filters the melted water such that the melted ice water is potable; and
a second filter system disposed at or near and in fluid communication with a spout positioned on one of the opposing end sides of the reservoir compartment, the second filter comprising a purifying water filter, wherein the spout includes a release mechanism for the melted ice being retained in the reservoir compartment.

10. The portable ice chest of claim 9, further comprising a visual indicator that communicates a condition of the second filter system.

11. The portable ice chest of claim 9, further comprising a second compartment positioned adjacent the first compartment in a side-by-side manner, the first and second compartments being separated by an impermeable barrier that is thermally conductive, so that ice in the first compartment may cool the contents of the second compartment, and wherein the second compartment is removable from portable ice chest.

12. The ice chest of claim 1, wherein the second filter system comprises a replaceable purifying filter.

13. A portable cooler, comprising:
a main body having a bottom, two opposing elongate sides, and two opposing end sides; and
a lid capable of being positioned over the main body and sealing the ice chest;
wherein the main body further comprises:
a first internal compartment and a removable second internal compartment arranged adjacent to the first internal compartment in a side-by-side manner, the first internal compartment being separated from the second internal compartment by a vertical barrier that permits thermal transfer, but prohibits liquid transfer therebetween, wherein the first and second internal compartments have open tops that are covered by the lid when the lid is placed in a closed position, wherein the first compartment receives water in either frozen or fluid form, and the second internal compartment is removable from the main body;
a third internal compartment positioned directly below the first and second internal compartments and positioned above the bottom of the main body,
a porous barrier positioned between the first and third internal compartments to allow liquid flow from the first compartment to the third compartment, the porous barrier having a first filter that filters water traveling between the first and third internal compartments;
a barrier disposed between the second internal compartment and the third internal compartment that prevents the flow of water into the second internal compartment from the third internal compartment; and
a water purifying filter disposed in the third internal compartment in fluid communication with a spout positioned on one of the opposing end sides of the third internal compartment, wherein the water purifying filter receives and purifies water from the third internal compartment and wherein the spout releases the purified water when the spout is opened.

14. The portable ice chest of claim 13, wherein the removable second compartment includes a handle to allow a user to remove the removable second compartment from the ice chest when the hinged lid when placed in an open position.

15. The portable ice chest of claim 13, wherein the first filter comprises a pre-filter that captures macro particles and a secondary filter that filters the from the first internal compartment such that water is potable.

16. The portable ice chest of claim 13, further comprising a collapsible handle positioned on an external side of the main body, the collapsible handle being capable of extending to a desired height upon actuation of a handle release mechanism.
